(19) United States
(12) Patent Application Publication
(10) Pub. No.: US 2008/0000119 A1
(43) Pub. Date: Jan. 3, 2008

(54) Motion toy gift box

(76) Inventor: Kun Yueh Chen, Taipei (TW)

Correspondence Address: PRO-TECHTOR INTERNATIONAL SERVICES, 20775 NORADA CT., SARATOGA, CA, 95070, US

(21) Appl. No.: 11/479,517

(22) Filed: Jun. 30, 2006

(51) Int. Cl. G09F 19/08

(52) U.S. Cl. 40/414

(57) ABSTRACT

A motion toy gift box is disclosed to include an outer box body, an inner box body accommodated in the outer box body, a plurality of rotation wheels, a plurality of ornaments mounted on the rotation wheels, a control circuit, a power drive mounted inside the outer box body and controlled by the control circuit to move the inner box body vertically in and out of the outer box body and to rotate the rotation wheels, and a sound and light circuit controlled by the control circuit to produce sound and visual effects.

### BACKGROUND OF THE INVENTION

1. Field of the Invention

The present invention relates to toy gift boxes and more particularly, to a motion toy gift box, which moves an inner box body in and out of an outer box body and simultaneously rotates rotation wheels in the inner body box when the user switched on the power switch.

2. Description of the Related Art

Various toy gift boxes and display toys are commercially available. However, most commercial toy gift boxes and display toys stand still. Still toy gift boxes and display toys are monotonous and less attractive. There are some motion toy gift boxes and display toys that use a musical box or motion mechanism to move movable toy parts. For example, U.S. Pat. No. 6,312,308 (equivalent to China Patent No. 99116998.0) discloses a motion display toy, which uses a control circuit to control reciprocating movement of a telescopic device and rotation of an annular rotary member.

In order to compete in the market, only more active and fantastic designs with sound and visual effects can attract the attention of the consumers.

### SUMMARY OF THE INVENTION

The present invention has been accomplished under the circumstances in view. According to one aspect of the present invention, the motion toy gift box comprises an outer box body, an inner box body accommodated in the outer box body, and a power drive mounted inside the outer box body and adapted to move the inner box body vertically in and out of the outer box body. According to another aspect of the present invention, the motion toy gift box further comprises at least one rotation wheel supported on the platform inside the inner box body and coupled to the power drive for rotation by the power drive. According to still another aspect of the present invention, the power drive can be controlled to rotate the at least one rotation wheel when moving the inner box body in and out of the outer box body or after having moved the inner box body out of the outer box body. According to still another aspect of the present invention, the motion toy gift box further comprises a box cover fixedly provided at a top side of the inner box body and adapted to close the outer box body when the inner box body is received inside the outer box body. According to still another aspect of the present invention, battery power supply means is provided inside the outer box body to provide the necessary working power to the power drive and the control circuit. According to still another aspect of the present invention, the control circuit comprises sound and light circuit means adapted to produce sound and emit light.

### BRIEF DESCRIPTION OF THE DRAWINGS

FIG. 1 is an elevational view of a motion toy gift box according to the present invention.

FIG. 2 is an exploded view of the motion toy gift box according to the present invention.

FIG. 3 is a sectional side view of the motion toy gift box according to the present invention.

FIG. 4 is a sectional front view of the motion toy gift box according to the present invention.

FIG. 5 corresponds to FIG. 3, showing the inner box moved out of the outer box according to the present invention.

FIG. 6 is a schematic drawing of the motion toy gift box, showing the links coupled between the respective drive gears and the respective transverse slots of the outer box body according to the present invention.

FIG. 7 is similar to FIG. 6 but showing the inner box body moved out of the outer box body.

FIG. 8 is a schematic top plain view of the motion toy gift box according to the present invention.

FIG. 9 is a perspective view of the present invention, showing the inner box body moved out of the outer box body.

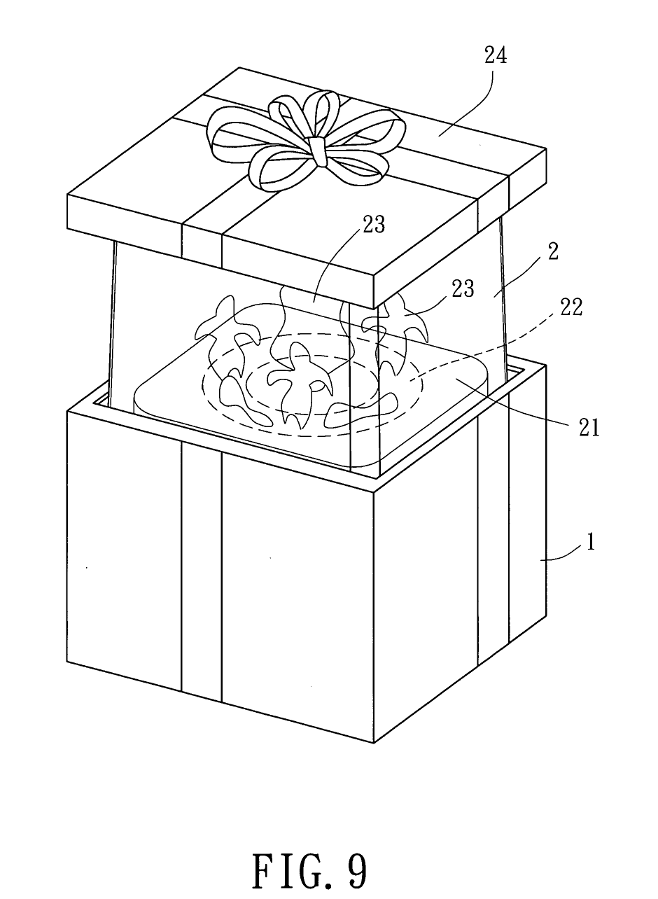

### DETAILED DESCRIPTION OF THE INVENTION

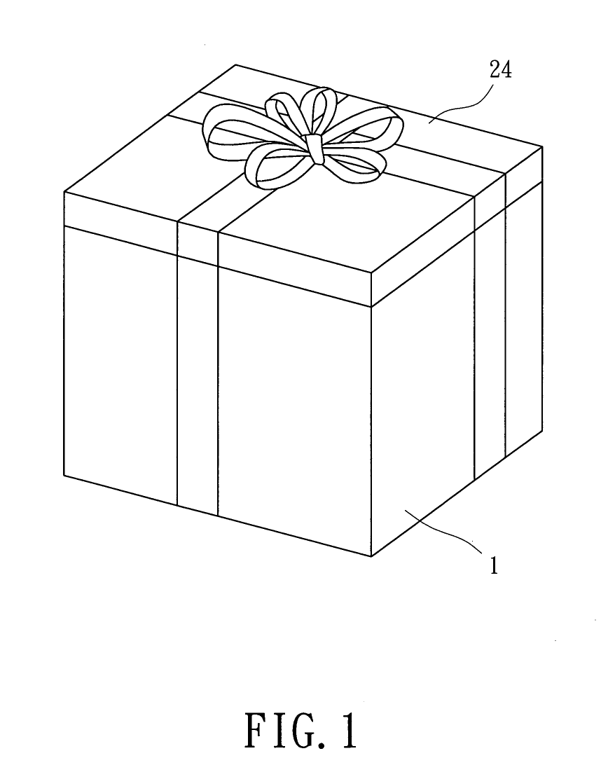

Referring to FIGS. 1˜4, a motion toy gift box in accordance with the present invention is shown comprised of an opaque outer box body 1, a transparent inner box body 2, and a power drive 3.

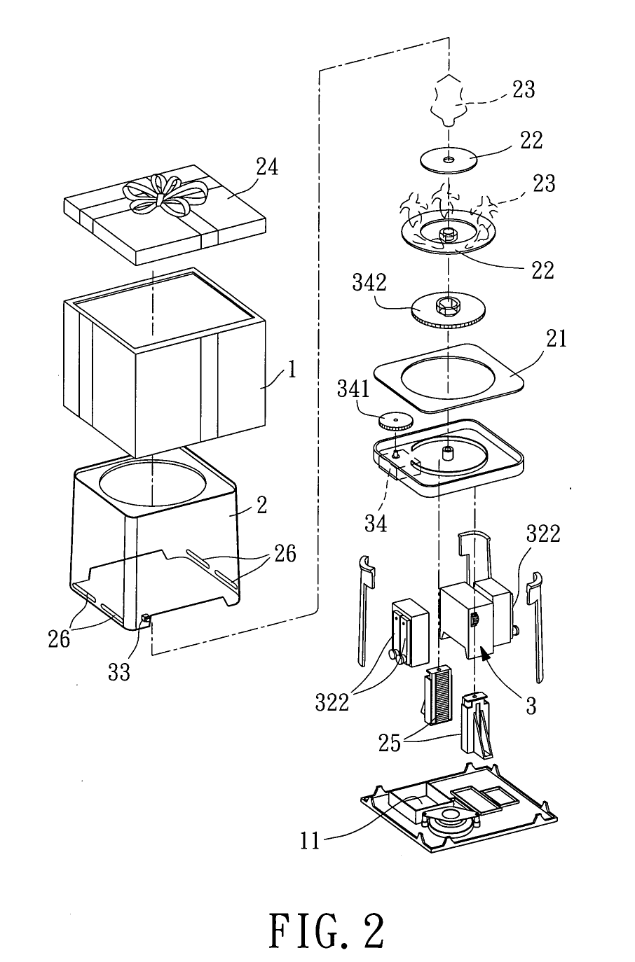

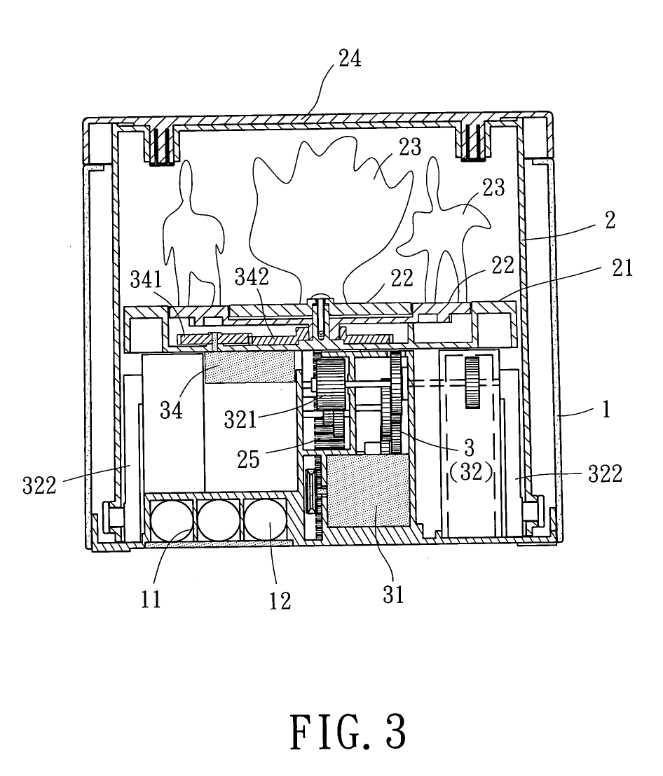

The outer box body 1 is adapted to accommodate the inner box body 2, having a battery chamber 11 (see FIGS. 2 and 3) holding a series of battery cells 12 (see FIG. 3) and a control circuit board (not shown) electrically connected to the series of battery cells 12.

The inner box body 2 is vertically movably accommodated in the outer box body 1, having a platform 21 on the inside, at least one, for example, two horizontal rotation wheels 22 concentrically arranged on the platform 21, and a plurality of ornaments 23 respectively supported on the horizontal rotation wheels 22 (see FIGS. 2, 3, 5 and 8). The ornaments 23 can be Santa Claus, deer, notable, sports star, . . . etc. The aforesaid control circuit can be controlled to produce a sound effect when controlling the power drive 3 to lift the inner box body 2 and/or to rotate the two horizontal rotation wheels 22 in same or reversed directions and/or to swing or rotate the ornaments 23. Further, a box cover 24 is fixedly provided at the top side of the inner box body 2. When the inner box body 2 is received inside the outer box body 1, the box cover 24 is closed on the top side of the outer box body 1, showing with the outer box body 1 the configuration of a house or building (i.e., the box cover 24 has the shape of the roof of a house or building).

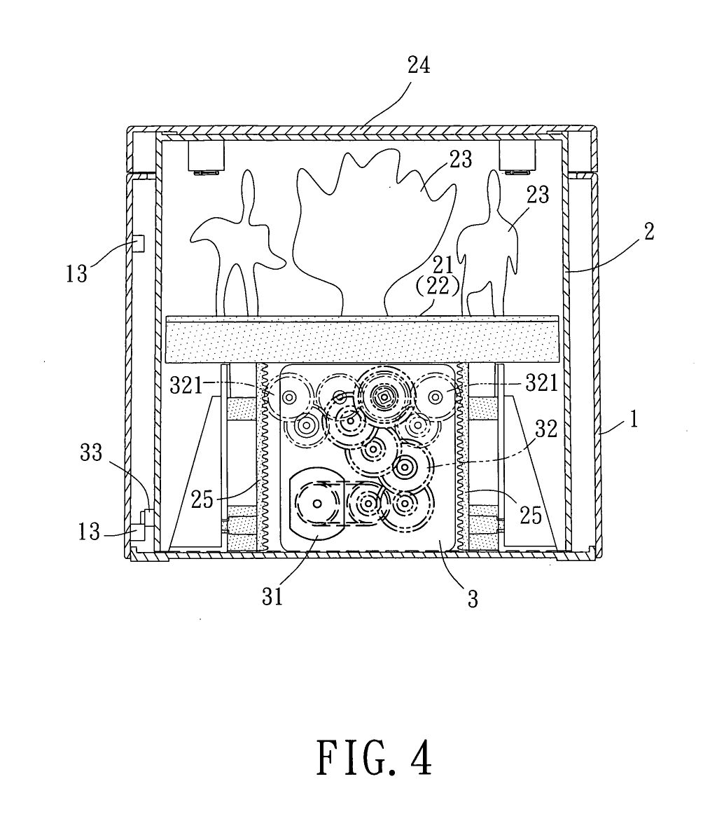

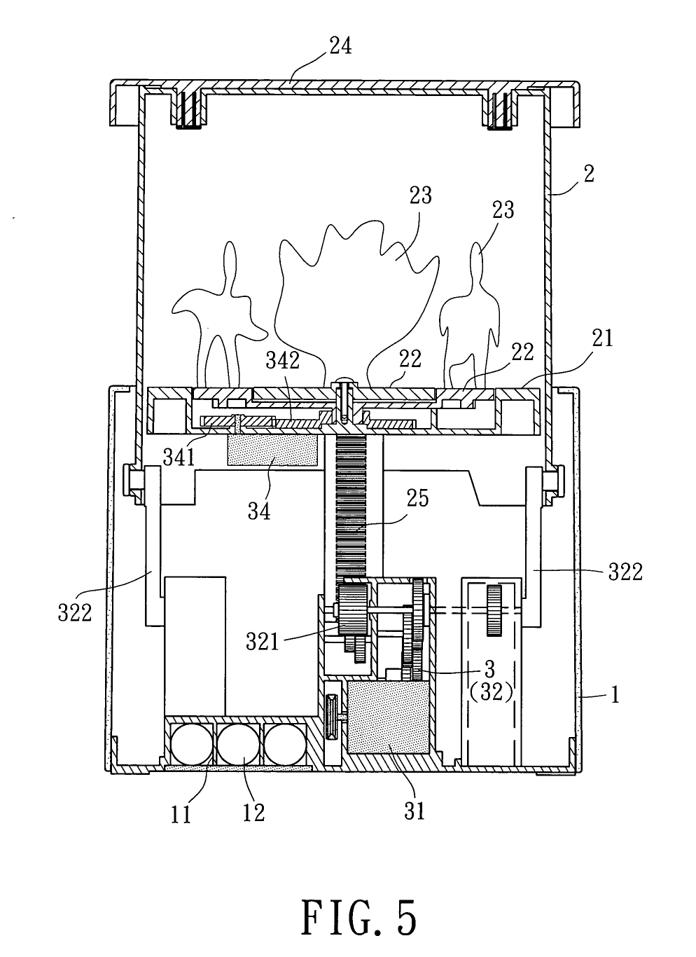

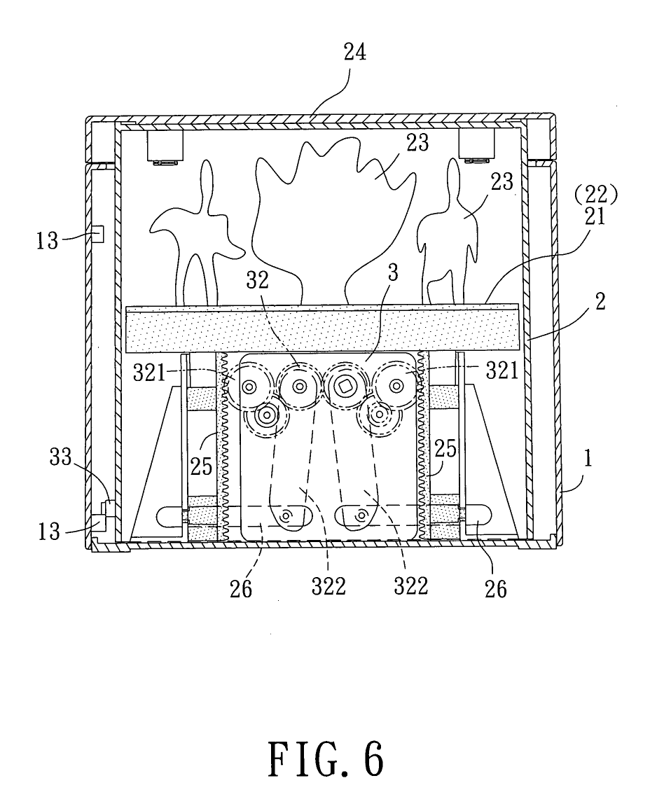

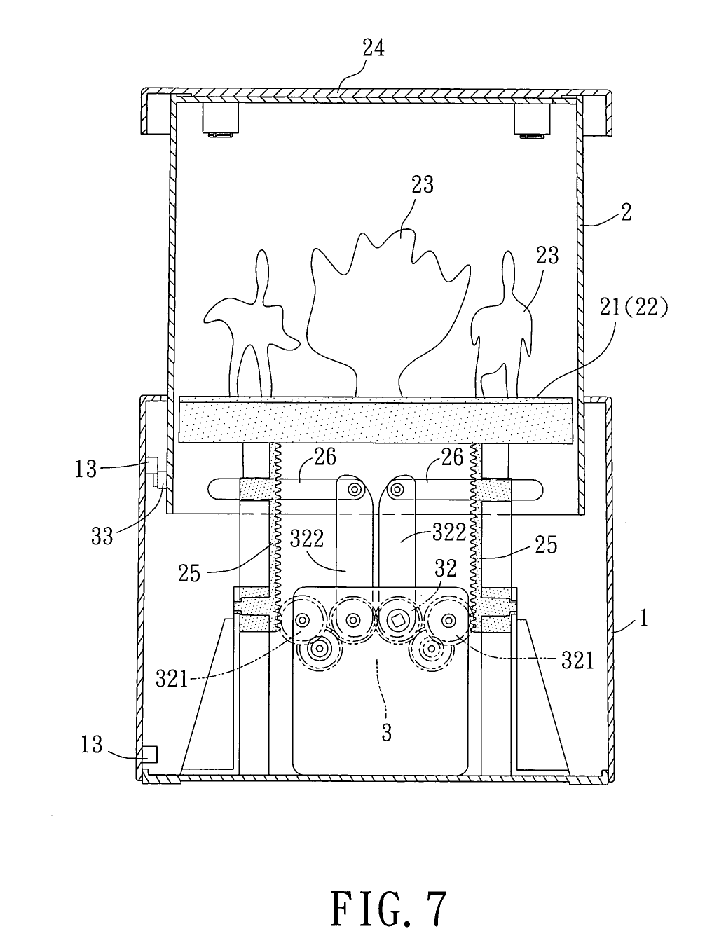

The power drive 3 is mounted inside the outer box body 1 below the platform 21 and controlled by the aforesaid control circuit to lift the inner box body 2 and/or to rotate the two horizontal rotation wheels 22 in same or reversed directions and/or to swing or rotate the ornaments 23. The power drive 3 comprises a first motor 31, a transmission gear set 32, and a micro switch 33 (see FIGS. 3 and 4). The first motor 31 is fixedly mounted inside the outer box body 1 and electrically coupled to the aforesaid control circuit to receive the control of the control circuit. The transmission gear set 32 is mounted inside the outer box body 1, comprising two drive gears 321 respectively meshed with a respective vertical rack 25 inside the outer box body 1 (see FIG. 4) and rotatable by the first motor 31 to move the inner box body 2 vertically in and out of the outer box body 1 (see FIGS. 3 and 5), two links 322 respectively coupled between the drive gears 321 and respective transverse slots 26 in the inner box 2 for enabling the inner box body 2 to be moved vertically in and out of the outer box body 1 during operation of the first motor 31 to drive the transmission gear set 32 (see FIGS. 6 and 7). The micro switch 33 is mounted on the inner box body 2 and electrically coupled to the aforesaid control circuit to control reversing of the rotation of the first motor 31. Further, two pegs 13 are fixedly provided inside the outer box body 1 at different elevations and vertically aligned for the touching of the micro switch 33 during the operation of the first motor 31 for enabling the micro switch 33 to control reversing of the first motor 31 (see FIGS. 6 and 7).

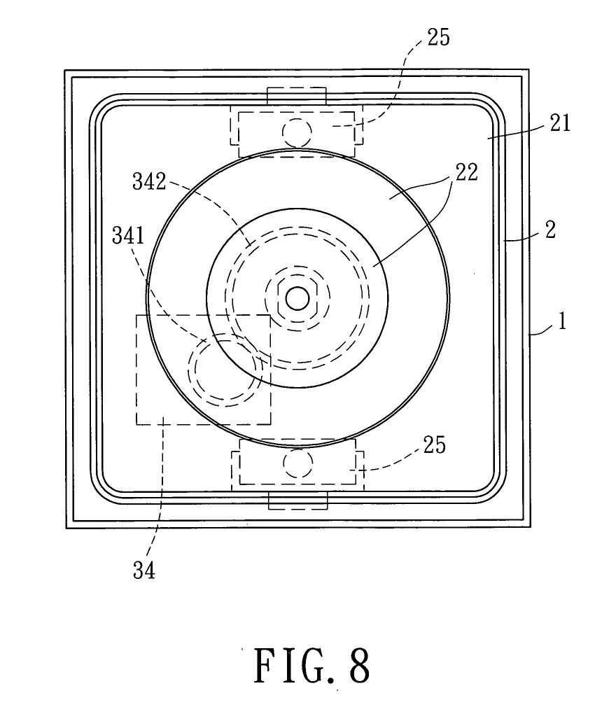

The power drive 3 further comprises a second motor 34 electrically coupled to the aforesaid control circuit (see FIGS. 3 and 8) adapted to rotate the horizontal rotation wheels 22 in the inner box body 2 by means of a drive gear 341 and a transmission gear 342.

Further, the outer box body 1 and/or the inner box body 2 may be decorated with other ornamental members and/or lamp bulbs, causing a sense of beauty. Further, the aforesaid control circuit can be designed having voice recording and playing means for recording and playing voices and/or music. The control circuit drives the decorated lamp bulbs to flash and the voice recording and playing means to play music when controlling the first motor 31 and the second motor 34 to move the inner box 2 and the horizontal rotation wheels 22 and the ornaments 23.

When the power supply is switched off, the box cover 24 is closed on the top side of the outer box body 1 (see FIGS. 1, 3 and 4), When the power supply is switched on, the control circuit starts the first motor 31 to move the transmission gear set 32, causing the drive gears 321 to move the respective vertical racks 25, and therefore the inner box body 2 is moved vertically out of the outer box body 1 by means of the effect of the links 322 that are coupled between the drive gears 321 and the transverse slots 26 of the inner box body 2 (see FIGS. 6 and 7). At the same time, the control circuit drives the voice recording and playing means to play a music and also drives the second motor 34 to rotate the horizontal rotation wheels 22 and also controls flashing of the lamp bulbs on the outer box body 1 and the inner box body 2, thereby producing sound and visual effects. When the inner box body 2 is moved to the designed upper limit position, i.e., when the micro switch 33 touches the top peg 13 (see FIG. 7), the first motor 31 is revered to lower the inner box body 2. On the contrary, when the inner box body 2 is moved to the designed lower limit position, i.e., when the micro switch 33 touches the bottom peg 13 (see FIG. 6), the first motor 31 is reversed to lift the inner box body 2.

Further, the outer box body 1 and the box cover 24 can be configured to show the outer appearance of a world famous building.

A prototype of motion toy gift box has been constructed with the features of FIGS. 1˜9. The motion toy gift box functions smoothly to provide all of the features discussed earlier

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A motion toy gift box comprising:
an outer box body;
an inner box body accommodated in said outer box body, said inner box body having a platform on the inside thereof; and
a power drive mounted inside said outer box body below said inner box and adapted to move said inner box body vertically in and out of said outer box body.

2. The motion toy gift box as claimed in claim 1, further comprising at least one rotation wheel supported on said platform inside said inner box body and coupled to said power drive for rotation by said power drive.

3. The motion toy gift box as claimed in claim 2, wherein said power drive is adapted to rotate said at least one rotation wheel when moving said inner box body in and out of said outer box body.

4. The motion toy gift box as claimed in claim 2, wherein said power drive is adapted to rotate said at least one rotation wheel when moved said inner box body out of said outer box body.

5. The motion toy gift box as claimed in claim 2, further comprising a box cover fixedly provided at a top side of said inner box body and adapted to close said outer box body when said inner box body is received inside said outer box body.

6. The motion toy gift box as claimed in claim 2, wherein said power drive comprises:
a first motor fixedly mounted inside said outer box body;
a transmission gear set, said transmission gear set comprising at least one vertical rack fixedly provided at said inner box body, at least one drive gear respectively meshed with said at least one vertical rack and coupled to said first motor for rotation by said first motor, and at least one link respectively coupled between said at least one drive gear and a respective transverse slot of said outer box body for moving said inner box body vertically in and out of said outer box body upon operation of said first motor;
a control circuit electrically connected to said first motor and adapted to control forward/backward rotation of said first motor; and
a micro switch electrically connected to said control circuit and adapted to drive said control circuit to reverse said first motor when said inner box body is moved vertically relative to said outer box body between a predetermined upper limit position and a predetermined lower limit position.

7. The motion toy gift box as claimed in claim 6, wherein said power drive further comprises a second motor electrically connected to said control circuit and controllable by said control circuit to rotate said at least one rotation wheel.

8. The motion toy gift box as claimed in claim 7, further comprising battery means provided inside said outer box body and electrically connected to said power drive to provide electricity to said power drive.

9. The motion toy gift box as claimed in claim 7, wherein said control circuit comprises sound and light circuit means adapted to produce sound and emit light.
